(19) United States
(12) Patent Application Publication
(10) Pub. No.: US 2012/0038078 A1
(43) Pub. Date: Feb. 16, 2012

(54) METHOD FOR INJECTION MOLDING OF PLASTIC PARTS

(76) Inventors: Andreas Praller, Germering (DE); Mikael Orsén, Trelleborg (SE); Günter Magnus, Neidenstein (DE)

(21) Appl. No.: 13/028,622

(22) Filed: Feb. 16, 2011

(30) Foreign Application Priority Data
Mar. 2, 2010 (DE) 102010009881.7
Mar. 11, 2010 (EP) 10002579.0
Jul. 29, 2010 (DE) 102010032756.5

(51) Int. Cl. B29C 45/57

(52) U.S. Cl. 264/85

(57) ABSTRACT

A method for producing plastic parts by a gas injection molding method by injecting a melt into a cavity and a flushing gas is fed into the cavity prior to the injection of the melt.

### CROSS REFERENCE TO RELATED APPLICATIONS

This application claims priority from German Patent Application No. 102010032756.5 filed Jul. 29, 2010, European Patent Application No. 10002579.0 filed Mar. 11, 2010 and German Patent Application No. 102010009881.7 filed Mar. 2, 2010.

### BACKGROUND OF THE INVENTION

The invention relates to a method for producing plastic parts according to the gas injection molding method, wherein a molding tool is closed to form a cavity in the interior of the molding tool, a plastic melt is injected into the cavity and a compressed gas is subsequently injected into the cavity.

### SUMMARY OF THE INVENTION

In the case of the injection molding method for producing plastic parts, a molding mass is liquefied and is injected into a molding tool as melt. The cavity of the molding tool determines the shape and surface structure of the plastic part, which is to be produced.

The gas injection molding method or gas injection molding is an alternative of the injection molding, in the case of which the molding mass is filled into the cavity of the molding tool and a compressed gas is subsequently injected into the melt via gas injectors under high pressure of up to 350 bar. The compressed gas displaces the melt, whereby hollow spaces can specifically be produced in the plastic part.

The entire process runs at high temperatures of up to 400° C., depending on the type plastic, which is to be processed, and at high pressures. Under these extreme conditions, the atmospheric oxygen can react with components of the plastic melt and can cause harmful oxidation reactions, resulting in contaminations of the gas injectors, an unstable process, an increased quantity of rejects, idle times and reduced quality.

For this reason, an inert gas, generally nitrogen, which does not react with the plastic melt even under extreme conditions in the molding tool, is used as compressed gas.

Until now, little attention was devoted to the fact that air is still present in the cavity in response to the injection of the plastic melt. It was assumed that air, which is present in the cavity, is displaced during the injection of the melt. However, it has become clear that the air, which is present in the cavity, is not displaced completely from the molding tool, but is also pressed into the gas injector, boreholes or blind holes in the cavity, for example, and remains there, depending on the density of the molding tool.

In response to the subsequent injection of the compressed gas into the plastic melt for molding the hollow space, this air is then first pressed into the melt before the inert compressed gas reaches into the melt. The oxygen contained in the air reacts with components of the plastic or with the additives, which are added to the plastic, wherein oxidation products are created, which contaminate the gas injectors and other system components, such as hoses and valves. In addition, the oxidation products have a negative impact on the surface quality of the created plastic parts. In extensive tests it was possible to confirm the negative impact of the air, which remained in the cavity.

The invention is thus based on a method for producing plastic parts, which avoids the above-mentioned harmful reactions, if possible.

It is a further object of the invention to provide for a method, by means of which molded plastic parts of a higher quality can be produced by means of the gas injection molding method.

It is a further object of the instant invention to prevent a contamination or clogging of the tool parts, in particular of the gas injectors.

One or a plurality of the afore-mentioned objects is/are solved by means of a method for producing plastic parts according to the gas injection molding method, wherein a molding tool is closed to form a cavity in the interior of the molding tool, a plastic melt is injected into the cavity and a compressed gas is subsequently injected into the cavity, and which is characterized in that a flushing gas is guided into the cavity prior to the injection of the melt. Advantageous embodiments are specified in the subclaims.

In the case of the method according to the invention, a flushing gas is guided into the cavity before the melt is injected into the cavity; in particular, the cavity is flushed with a flushing gas. By introducing flushing gas into the cavity according to the invention, air which is present in the cavity, is at least partially displaced and is replaced with the flushing gas. The melt is subsequently injected into the cavity and is molded.

The term “melt” is to comprise any type of molding mass, which encompasses a suitable viscosity so as to be molded into the desired plastic part in a cavity.

The term “cavity” refers in particular to a hollow space in a molding tool or injection molding tool, which determines or at least co-determines the external shape of the plastic part, which is to be produced. The cavity represents a female mold of the plastic part, which is to be produced, or of a portion of the desired plastic part. As a rule, the cavity is tight insofar as no melt escapes from the cavity. In contrast, the cavity is not necessarily designed to be gas-tight. The injected flushing gas can escape from the cavity, in particular via supply or discharge lines, gaps or other leaks.

The terms “tool” and “molding tool” are used synonymously in the context of this application and characterize an injection molding tool, which encompasses a cavity, which is suitable for producing a plastic part. As a rule, the tool serves to produce large quantities of plastic parts. The plastic is injected into the tool at high pressure, the plastic part cools down and is ejected from the tool after a certain time.

The term “flushing” refers to the supply, injection or other addition of a flushing gas into the cavity, so as to at least partially displace the air, which is present in the cavity, and so as to reduce the oxygen content in the cavity.

As a rule, the injection molding tool consists of two or more tool parts, which can be moved separate from one another or relative to one another, so as to open and close the tool or the cavity, respectively. In the case of the method according to the invention, the tool is closed initially, so that a cavity forms in the tool. The cavity is then flushed with the flushing gas. The air, which is initially present in the cavity, is thereby pressed out of the cavity and escapes via the opening, via which the melt is to be supplied, via a possible gap or a leak between the individual tool parts or via another connection of the cavity to the environment.

By flushing the cavity, the oxygen content of the atmosphere, which is located in the cavity, is reduced and the cavity is inerted or at least partially inerted. The oxygen content is thereby preferably lowered to the extent that it is less than 10% by volume, more preferably less than 1% by volume, most preferably less than 0.1% by volume.

In response to the injection of the plastic melt into the cavity, a better part of the atmosphere, which is located in the cavity, is displaced. However, as mentioned above, air can remain in holes, boreholes or narrow depressions and can then cause undesired oxidation reactions. It has proved itself, in particular in the case of cavities comprising narrow or deep boreholes or gaps, to introduce the flushing gas directly into the mentioned depressions, holes and boreholes. In this case, it is oftentimes not necessary to inert the entire cavity.

By replacing the air, which is located in the cavity, with the flushing gas, the oxidizing components in the atmosphere are reduced within the cavity, so that they no longer react with components of the plastic. Oxidation reactions with the plastic or additives, respectively, are reduced or avoided. This results in a lower contamination of the tool. Consequently, the cleaning times can be shortened. The maintenance and cleaning effort for the tools is reduced and the productivity increases. High-quality molded plastic parts comprising a high surface quality can further be produced. The processes run in a more stable manner, thus reducing the number of rejects.

The invention is suitable for all injection molding processes, but provides particular advantages in the case of the gas injection molding method. In the case of this method, a compressed gas is injected into the mold after the injection of the melt into the cavity, so as to press the melt against the walls of the cavity and to create a hollow space in the interior. The compressed gas is injected into the melt via one or a plurality of gas injectors, which is/are connected to the cavity, at high pressure.

Contrary to the foaming methods, in the case of which a propellant gas is added to the melt, is dissolved therein and the melt is then injected into the cavity together with the propellant, the gas addition, that is, the compressed gas addition, takes place only after the melt has been injected into the cavity in the case of the gas injection molding. Melt and compressed gas first come into contact with one another in the cavity.

Until now, one was of the opinion that the air, which is located in the cavity, is displaced from the cavity in response to the injection of the melt. In the case of the common method, however, it has become clear that a portion of the air is displaced into the connection points of the gas injectors against the cavity by the injected melt. In response to the injection of the compressed gas, this air is then pressed back into the melt again and causes the described negative oxidation reactions. The air is also flushed from the connection points of the gas injectors by means of the flushing according to the invention and is replaced with the flushing gas. After this flushing process has ended, the plastic is injected into the cavity and, as a result, the normal gas injection molding is carried out. This means that the steps flushing gas supply, injection of the melt and injection of the compressed gas take place successively, and not simultaneously, not even partially.

The invention is suitable for the blow-up method, in the case of which the cavity is only partly filled with melt and is subsequently pressed against the walls of the tool by means of the compressed gas, thus resulting in a hollow body, as well as for the ancillary cavity method. In the latter method, the cavity is initially filled completely with the melt. In a second step, a portion of the melt is pressed into an ancillary cavity, which is connected to the cavity, by means of the compressed gas. The invention can further be used advantageously in the case of external gas molding. In the case of this method, a compressed gas is used to compress the plastic or the plastic melt, respectively, similarly as in the case of punching.

Preferably, an inert gas is used as flushing gas and/or as compressed gas. Inert gases, such as nitrogen, carbon dioxide, argon or helium or mixtures of these gases are particularly suitable for this purpose.

It is further advantageous to use a gas, which has a reducing effect, as flushing gas and/or as compressed gas or to add a reducing gas additive to the flushing gas and/or to the compressed gas. Hydrogen (H₂), carbon monoxide (CO) or ammonia (NH₃) are suitable for this. The flushing can also take place by means of an inert gas comprising a reducing gas additive, e.g. by means of nitrogen, to which hydrogen was added as reducing component, for example with a gas mixture of 95% of N₂ and 5% of H₂ (forming gas).

It can furthermore be advantageous to flush the cavity successively with different gases or gas mixtures. For example, the cavity can initially be inerted with nitrogen, and a gas, which has a reducing effect, or another inert gas, such as helium, e.g., can then be introduced for ending the flushing phase.

Preferably, the same type of gas is used as flushing gas and as compressed gas; it is advantageous, in particular, to use nitrogen for flushing and as compressed gas for molding.

In a most preferably embodiment, the flushing gas and the compressed gas are injected into the cavity via the same injector. In so doing, a particularly good flushing of the connection points of the gas injectors to the cavity is ensured. Possible dead spaces at the connection or the terminals, respectively, of the gas injectors, which are provided for supplying the compressed gas, are thus flushed thoroughly. The oxygen content in the cavity is reduced reliably. In response to the inject of the compressed gas, only flushing gas, which preferably does not contain any oxidizing components, is pushed back into the melt.

In the event that the cavity encompasses further non-continuous boreholes, blindholes, cuts or narrow depressions in addition to or instead of the terminals for the gas injectors, it is advantageous to supply the flushing gas (also) directly to the cavity via these locations, so as to flush it well.

Most preferably, the same injectors also supplies the same gas type as flushing gas and as compressed gas, that is, the same gas type is used for flushing as well as for later molding the melt or the plastic, respectively, and is in each case injected into the cavity via the same gas injector.

Typical systems for the gas injection molding method are equipped with pressure regulating modules, by means of which the point in time and the duration of the supply of the compressed gas and of the pressure, at which the compressed gas is injected into the mold, are adjusted and regulated. In a preferred embodiment of the invention, these pressure regulating modules are also used to control and regulate the flushing gas supply. The point in time of the flushing gas supply, the duration and the flushing gas pressure of which are controlled and regulated by means of a pressure regulating module, which also regulates the supply of the compressed gas. Through this, additional switch-over or regulating elements are not required and the number of valves is also kept as small as possible.

Advantageously, the pressure regulating module as well as the elements, which are necessary for supplying and controlling the compressed gas, such as high-pressure valves or gas injectors, for example, are also used for the flushing of the mold according to the invention. For instance, a signal for starting the flushing process is sent to the pressure regulating module after the closing of the mold, for example. The pressure regulating module then starts the supply of the flushing gas at a predetermined flushing gas pressure. The flushing period is preferably also preset at the pressure regulating module. After the flushing period has ended, the flushing gas supply is interrupted and a plastic melt is injected into the flushed and thus essentially oxygen-free cavity. The actual gas injection is started by means of a second signal, that is, the compressed gas is injected into the plastic melt, that is, into the plastic, which is still molten. The injection of the compressed gas takes place according to predetermined parameters and is regulated via the same pressure regulating module, which also controls or regulates, respectively, the flushing gas supply. Nitrogen is preferably used as flushing gas and as compressed gas.

On principle, it is advantageous to supply the flushing gas to the cavity such that a flushing gas flow, which covers the entire cavity, if possible, is created. In so doing, it is ensured that the air, which is present in the cavity, is displaced quickly and as completely as possible.

In this respect, it proved to be advantageous to supply the flushing gas at a location of the cavity, which, if possible, is located opposite to an opening of the cavity to the environment, via which the displaced air can escape from the cavity. In so doing, the entire cavity is flushed well. It is ensured that dead spaces, which the flushing gas cannot reach or can reach only insufficiently, do not remain.

In response to supplying the flushing gas via the gas injector for the compressed gas, the air can escape via the injection point in the cavity, for example, that is, via an opening, via which the melt is injected into the cavity and which is closed by the injection nozzle of the machine so as to be sealed for the melt, but not in a gas-tight manner prior to the injection of the melt. Oftentimes, this injection point is located at the end of the cavity opposite to the gas injector, so that the cavity is flushed well, that is, the air is displaced and a sufficient reduction of the oxygen concentration is reached.

Advantageously, the flushing gas is introduced into the cavity at a pressure of between 5 and 30 bar.

Preferably, the flushing process takes place with the flushing gas for a period of from 1 to 5 seconds. It becomes clear that this time period is sufficient to inert the cavity to the extent that hardly any oxidation reactions of the plastic melt occur with the cavity atmosphere. The flushing gas flow is preferably kept constant during this time period. However, in individual cases, it may also be advantageous to vary the flushing gas flow.

In a preferred embodiment of the invention, the flushing gas has a temperature of between 15° C. and 30° C., preferably between 17° C. and 25° C. In particular in response to the production of plastic parts, on the surface quality of which increased demands are not made, it proved itself to introduce the flushing gas into the cavity at ambient temperature.

In the case of increased demands on the surface quality of the plastic parts, the flushing gas is fed into the cavity at a temperature of between 20° C. and 120° C., more preferably between 40° C. and 90° C. The temperature of the flushing gas should preferably be so high that the location of the cavity wall, which the flushing gas flow sprayed into the cavity, strikes, is not cooled down too much. Otherwise, a location of the cavity wall, which is colder as compared to the remaining cavity and at which the subsequently injected melt hardens more rapidly than in the remaining cavity, is formed, whereby different surface qualities or even surface errors, such as the formation of shadows, e.g., can appear on the plastic parts. Preferably, the temperature of the flushing gas is thus adapted to the temperature of the cavity wall, that is, the flushing gas is fed with the temperature of the cavity wall. In this case, a local cool-down of the cavity is avoided. The temperature of the cavity is chosen as a function of the plastic, which is to be processed, preferably at value of between 40° C. and 80° C.

Preferably, the flushing gas temperature deviates from the temperature of the cavity wall by not more than 10° C. The temperature of the flushing gas is crucial when it strikes the wall of the cavity. At this point in time, the flushing gas temperature and the cavity temperature should be as close as possible, so as not to locally change the temperature of the cavity at the location where the flushing gas strikes the cavity. In response to the injection of the flushing gas into the cavity, the flushing gas expands to a certain extent and cools down slightly. Advantageously, the temperature of the flushing gas prior to the introduction into the cavity is thus chosen to be up to 10° C. higher than the temperature of the cavity.

### BRIEF DESCRIPTION OF THE DRAWINGS

The invention as well as further details of the invention will be specified below in more detail by means of exemplary embodiments, which are illustrated in the drawings.

FIG. 1 shows a gas supply for carrying out a gas injection molding method according to the invention.

FIG. 2 shows the course of the flushing gas flow over time.

FIG. 3 shows the course of the compressed gas flow over time.

### DETAILED DESCRIPTION OF THE INVENTION

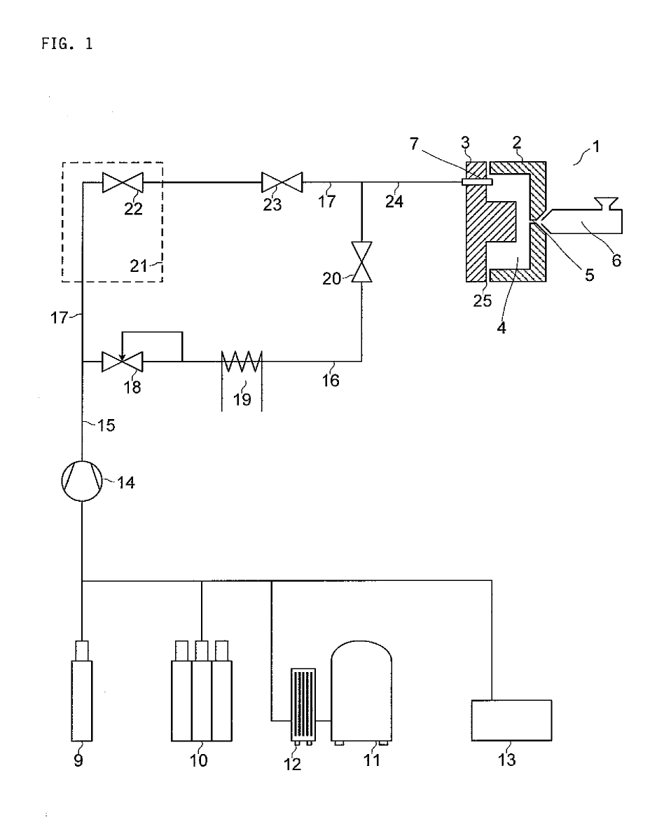

FIG. 1 shows schematically a system for producing plastic parts by means of the gas injection molding technology. The injection molding tool 1 is embodied in two pieces from a first molded part 2 and a second molded part 3. The two molded parts 2, 3 form a cavity 4, into which a plastic melt can be injected. For this purpose, the tool element 2 is provided with a connection opening 5, to which an injection device 6 is connected. The injection device 6 encompasses a screw conveyor, which is not illustrated in the figure and by means of which a plastic melt can be supplied into the cavity 4. For reasons of clarity, FIG. 1 illustrates an injection molding tool 1 with only one cavity 4. It goes without saying that the invention can also be used for tools comprising a plurality of cavities.

The second molded part 3 encompasses a gas injector 7, which is connected to a gas supply system, which provides gaseous nitrogen at a high pressure. A plurality of possible gas sources for supplying the injection molding tool with nitrogen are illustrated in FIG. 1, one or also a plurality of which can be used.

The nitrogen can be stored in a single compressed gas cylinder 9 or in a cylinder bundle 10 in gaseous state. In the alternative, liquid nitrogen can also be removed from a liquid tank 11 and can subsequently be evaporated in an evaporator 12. Likewise, it is possible to obtain gaseous nitrogen by means of a membrane or PSA system 13.

A gas compressor 14, which provides for an increase of the pressure of the gaseous nitrogen to up to 500 bar, preferably 300 to 350 bar, is connected to the gas source(s). Downstream of the gas compressor 14, the gas supply line 15 branches into a flushing gas supply line 16 and into a compressed gas supply line 17.

Provision is made in the flushing gas supply line 16 for a pressure reducer 18, a heating device 19 for heating the nitrogen, and a cut-off valve 20. The pressure reducer 18 provides for a reduction of the pressure of the supplied nitrogen to a value of between 3 and 50 bar, preferably between 5 and 30 bar.

Provision is made in the compressed gas supply line 17 for a regulating module 21 comprising a regulating valve 22 and a cut-off valve 23.

Downstream from the cut-off valves 20, 23, the flushing gas supply line 16 and the compressed gas supply line 17 are brought together into a gas supply 24, to which the gas injector 7 is connected.

The method according to the invention will be described below in an exemplary manner by means of the device illustrated in FIG. 1.

Gaseous nitrogen is removed from the gas source 9, 10, 11, 12, 13 and is supplied to the gas compressor 14. The pressure of the nitrogen is increased to 330 bar by means of the gas compressor 14 and is guided into the flushing gas supply line 16 and into the compressed gas supply line 17. The cut-off valves 20 and 23 in the flushing gas supply line 16 or in the compressed gas supply line 17, respectively, are closed initially.

The injection device 6 is arranged relative to the connection opening 5 such that a liquid-tight connection is created. However, the contact between injection device 6 and connection opening 5 is not gas-tight.

Prior to the injection of the plastic melt, the molded parts 2, 3 are brought together to close the injection molding tool 1, so that the cavity 4 is formed between the molded parts 2, 3. The cavity 4 is then flushed with the flushing gas. For this purpose, the pressure of the nitrogen in the flushing gas supply line 16 is lowered to a value of from 5 bar to 30 bar by means of the pressure reducer 18. Subsequently, the nitrogen is heated by means of the heating device 19, for example to a temperature of up to 90° C., preferably to a temperature of between 40° C. and 80° C.

The cut-off valve 20 is opened and the heated nitrogen flows into the cavity 4 as flushing gas via the gas supply 24 and the gas injector 7. The nitrogen flowing into the cavity 4 displaces the air, which is located in the cavity 4 and which escapes into the environment via gaps or openings 25 between the molded parts 2, 3 or via the connection opening 5 for the injection device 6. The flushing process with nitrogen takes place for a period of 2 to 4 seconds. The flushing period is preferably set such that the oxygen content in the cavity has decreased to less than 10% by volume, preferably to less than 5% by volume, after the flushing. Subsequently, the cut-off valve 20 is closed again.

The injection of the plastic melt into the substantially oxygen-free cavity 4 takes place now. After the provided quantity of plastic melt has been injected into the cavity 4, the injection of the compressed gas into the plastic melt located in the cavity 4 is carried out.

The pressure of the nitrogen, which flows in the compressed gas supply line 17, is set to a value of between 50 and 250 bar via the regulating module 21 and the regulating valve 22. The exact pressure depends on the type of the processed plastic and on the product, which is to be produced. It is also possible to regulate the pressure according to a predetermined curve or as a function of predetermined parameters, for example the temperature of the plastic.

After the injection of the plastic melt and the injection of the compressed gas, the pressure of the compressed gas is maintained in the interior of the plastic part. By maintaining the pressure in the interior of the plastic part, the outer surface of the plastic part is pressed against the inner surface of the cavity. In the meantime, the plastic part cools down and solidifies. When the plastic part has hardened, the valve 23 is closed again and the pressurization of the plastic part with compressed gas is ended. The nitrogen, which is used as compressed gas, is either collected via a non-illustrated gas recovery system and is reused or is released into the environment. After the pressure has been reduced in the injection molding tool 1, the tool 1 can be opened and the created plastic part can be removed or ejected, respectively.

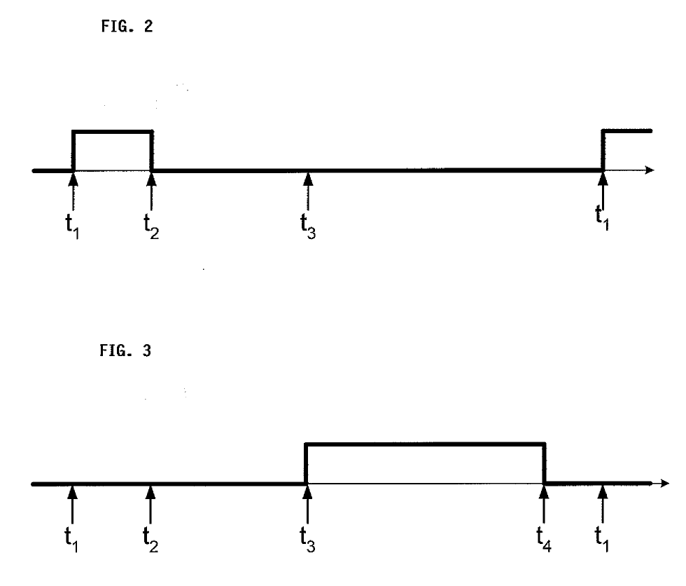

FIGS. 2 and 3 show the dependency of the flushing gas flow (FIG. 2) and of the compressed gas flow (FIG. 3) from the time. The injection molding tool 1 is closed at the point in time t₁. Starting at this point in time, the cavity 4 is flushed until the onset t₂ of the injection of the plastic melt. It can be seen in FIG. 2 that a constant flow of flushing gas—nitrogen in the instant case—is guided through the cavity 4 during the time period t₁ to t₂, that is, from the closing of the injection molding tool to the injection of the melt.

Preferably, as shown in FIG. 2, the flushing gas flow is kept constant during the flushing. However, it may also be advantageous to vary the flushing gas flow during the flushing, that is, to change the quantity of flushing gas, which is guided in or through the cavity, respectively, as a function of the time, the oxygen content in the atmosphere in the cavity, the shape of the cavity or other parameters.

FIG. 3 shows the course of the compressed gas flow. The compressed gas is guided into the cavity 4 at a point in time t₃, at which the injection of the plastic melt has finished. Preferably, the pressurization with compressed gas takes place directly after the injection of the melt has ended. The compressed gas flow is maintained until the plastic part has cooled down and can be removed (point in time t₄). After this, a new injection molding cycle can begin.

1. A method for producing plastic parts according to the gas injection molding method, wherein a molding tool is closed to form a cavity in the interior of the molding tool, a plastic melt is injected into the cavity and a compressed gas is subsequently injected into the cavity, characterized in that a flushing gas is guided into the cavity prior to the injection of the melt.

2. The method according to claim 1, characterized in that an inert gas is used as either the flushing gas or the compressed gas.

3. The method according to claim 1, characterized in that a gas that has a reducing effect is used as either the flushing gas or the compressed gas.

4. The method according to claim 1, characterized in that the flushing gas or the compressed gas is selected from the group consisting of nitrogen, carbon dioxide and argon.

5. The method according to claim 1, characterized in that the flushing gas or the compressed gas is selected from the group consisting of hydrogen, carbon monoxide and ammonia.

6. The method according to claim 1, characterized in that the flushing gas and the compressed gas are injected into the cavity via a same injector.

7. The method according to claim 1, characterized in that the flushing gas is introduced into the cavity at a pressure of between 5 and 30 bar.

8. The method according to one of claim 1, characterized in that the cavity is flushed with the flushing gas for 1 to 5 seconds.

9. The method according to claim 1, characterized in that the flushing gas has a temperature of between 15° C. and 30° C.

10. The method according to claim 1, characterized in that the flushing gas has a temperature between 17° C. and 25° C.

11. The method according to claim 1, characterized in that the flushing gas has a temperature of between 20° C. and 120° C.

12. The method according to claim 1, characterized in that the flushing gas has a temperature between 40° C. and 90° C.

13. The method according to claim 1, characterized in that the injection of the compressed gas into the cavity and the introduction of the flushing gas into the cavity are regulated by means of a same pressure regulating module.
